(19) United States
(12) Patent Application Publication
(10) Pub. No.: US 2017/0249708 A1
(43) Pub. Date: Aug. 31, 2017

(54) SYSTEMS AND METHODS OF AGGREGATING AND DELIVERING INFORMATION

(71) Applicant: Anyone Media Network, Inc., Menifee, CA (US)

(72) Inventor: Charles W. SIMMONS, Menifee, CA (US)

(21) Appl. No.: 15/512,109

(22) PCT Filed: Sep. 18, 2015
(86) PCT No.: PCT/US2015/050848

§ 371 Date: Mar. 17, 2017

Related U.S. Application Data
(60) Provisional application No. 62/053,125, filed on Sep. 20, 2014.

(51) Int. Cl. G06Q 50/00; H04L 29/08; G06F 17/30

(52) U.S. Cl. CPC G06Q 50/01; G06F 17/3089; H04L 67/306; H04L 67/02

(57) ABSTRACT

Systems and methods useful in transmitting information from celebrity-providers to fan-users are provided. System and methods include a global data structure representing at least one celebrity-provider profile, an internal data structure coupled to the global data structure, and a computer server coupled to the global data structure and the internal data structure. The internal data structure includes a handler class programmed to convert raw celebrity-provider data into organized celebrity-provider data, at least one model representing celebrity-provider data, at least one view attached to a corresponding model and being programmed to retrieve the celebrity-provider data from the corresponding model, and a controller coupling the system to one or more fan-users. The model accesses the at least one handler class. The controller is programmed to provide at least one view to one or more fan-users. The internal data structure is programmed to combine multi-platform online assets of a celebrity-provider into a single uniform network accessible by fan-users.

### CROSS-REFERENCE TO RELATED APPLICATION

This application claims priority to and benefit of U.S. Application Ser. No. 62/053,125 filed Sep. 20, 2014, which is hereby incorporated by reference in its entirety.

### FIELD

The present disclosure relates to systems and methods of transmitting information from celebrity-providers to fan-users.

### BACKGROUND

Over the last several years, the number and availability of entertainment-and-media discovery platforms have skyrocketed. With services like Pandora®, Spotify®, Vimeo®, and Youtube®, there is no shortage of high-quality discovery/streaming apps. These and other current platforms focus only on limited aspects of a provider's presence, i.e., events or music or merchandise. Where these apps fall short are in grabbing the important information. The user already knows he or she likes the song, the artist, the music video, or the music trailer, but fan-users often want more.

If the fan-user wants to know where the band is going to be playing next, or wants to buy some of their merchandise, or wants to see which actors are in the movie trailer they just watched, the fan-user has to leave the originating app, open up her browser, and search through endless possibilities to find this additional information. These and other holes in social media publishing applications are significant problem for celebrities and their fans.

Currently, there are no technologies or platforms that provide users with a 360-degree view of their favorite celebrities. Thus, many users find desired features missing from their mobile experience. Users are left feeling limited or restricted, as the experience is lost in a pool of sub-pages and dialogs.

Accordingly, there is a need for an online platform that allows consumers a quick and complete view of all relevant information related to their favorite celebrities. There is a need for a solution that provides fans with an easy-to-use catalog of their favorite providers with the most important and current information delivered in an intuitive manner. There is also a need for a quick, efficient, and user-friendly platform for accessing the celebrity information. The present disclosure provides solutions by novel computer technology to overcome the above-mentioned problems which specifically arise in the realm of computer networks.

### SUMMARY

The present disclosure, in its many embodiments, alleviates to a great extent the disadvantages of known social media publishing applications and discovery/streaming apps by providing a platform for entertainment-centered musicians, athletes, and other celebrities and brand owners to deliver complete information about themselves to their audiences and allow fans to select what kind of information they want to receive about their favorite celebrities. The disclosed systems and methods advantageously providing not just a discovery service, but a complete immersifying experience. Disclosed systems and methods allow celebrity-providers or other content providers to present their audience with a complete database of auto-aggregating information including every aspect of their brand as a whole. This gives the fans an all-in-one experience.

It is an object of the present disclosure to provide turn-key set-up for the celebrity-provider or content provider. It is an object of the present disclosure to allow the celebrity-provider to integrate all aspects of his brand into a simple-to-use interface. It is another object of the present disclosure to allow the celebrity-provider to have as much or as little control of her information as she wants. It is an object of the present disclosure to provide the celebrity-provider the option to leave his profile on “auto pilot” where exemplary embodiments automatically pull information, or allow the celebrity-provider to manually manage his profile. It is another object of the present disclosure to verify each celebrity-provider for authenticity. It is an object of the present disclosure to provide different pricing brackets for a celebrity-provider budget. It is another object of the present disclosure to provide an expandable network so celebrity-providers can connect with one another to expand their visibility across industries. It is an object of the present disclosure to ensure consistency with current web trends and mobile standards and ensure ongoing technology changes are made to remain cutting-edge and relevant. It is another object of the present disclosure for the services to be free for the fan-user.

Exemplary embodiments include a system useful in transmitting information from celebrity-providers to fan-users, the system comprising a global data structure representing at least one celebrity-provider profile, an internal data structure coupled to the global data structure, and a computer server coupled to the global data structure and the internal data structure. The internal data structure includes a handler class programmed to convert raw celebrity-provider data into organized celebrity-provider data, at least one model representing celebrity-provider data, at least one view attached to a corresponding model and being programmed to retrieve the celebrity-provider data from the corresponding model, and a controller coupling the system to one or more fan-users. The model accesses the at least one handler class. The controller is programmed to provide at least one view to one or more fan-users. The internal data structure is programmed to combine multi-platform online assets of a celebrity-provider into a single uniform network accessible by fan-users.

In exemplary embodiments, the system further comprises a fan-user interface coupled to the computer server. In exemplary embodiments, the internal data structure aggregates celebrity-provider data from online social networks specified by the celebrity-provider. In exemplary embodiments, fan-users can subscribe via a web application. The celebrity-provider data may be held in unique XML files generated from at least one model and at least one handler class. The system may further comprise at least on temporary data structure stored on a fan-user device.

In exemplary embodiments, the controller allows the one or more fan-users to enter one or more messages relating to desired views and transmits the messages to at least one view. The view may receive the messages from the controller and performs one or more of: highlighting and suppressing certain attributes of the corresponding model such that the view presents the attributes of the model desired by the one or more fan-users. In exemplary embodiments, the system further comprises one or more of: a micro-blog account associated with a celebrity- provider and a micro-blog account associated with a fan-user. In exemplary embodiments, the celebrity-provider is one or more of: an artist, an entertainer, an athlete, a musical group, a brand, or a representative. In exemplary embodiments, the organized celebrity-provider data is presented by a card UX structure.

Exemplary embodiments include methods of communicating information between celebrity-providers and fan-users. Exemplary methods comprise aggregating raw celebrity-provider data specified by a celebrity-provider, converting the raw celebrity-provider data into organized data chunks, accessing the organized celebrity-provider data and directing the organized celebrity-provider data to a model or controller, retrieving the organized celebrity-provider data from the model or controller, allowing one or more fan-users to enter one or more messages relating to desired attributes of the organized celebrity-provider data, and performing one or more of: highlighting and suppressing certain attributes of the organized celebrity-provider data and presenting the desired attributes of the organized celebrity-provider data to the one or more fan-users.

In exemplary embodiments, methods further comprise collecting and storing unique fan-user identifying information. Exemplary methods further comprise allowing a celebrity-provider to create at least one celebrity-provider profile. Exemplary methods further comprise creating at least on temporary data structure stored on a fan-user device. Exemplary methods further comprise providing a fan-user interface for presenting the desired attributes of the organized celebrity-provider data to the one or more fan-users. In exemplary methods, fan-users can subscribe to receive the desired attributes of the organized celebrity-provider data via a web application. Exemplary methods further comprise holding the celebrity-provider data in unique XML files. Exemplary methods further comprise linking the fan-user interface to a micro-blog account associated with the fan-user. Exemplary methods further comprise retrieving raw celebrity-provider data from a micro-blog account associated with the celebrity-provider. In exemplary methods, the celebrity-provider is one or more of: an artist, an entertainer, an athlete, a musical group, a brand, or a representative.

Accordingly, it is seen that systems and methods of transmitting information from celebrity-providers to fan-users are provided. Disclosed systems and methods provide a platform for entertainment-centered musicians, athletes, and other celebrities and brand owners to deliver complete information about themselves to their audiences and allow fans to select what kind of information they want to receive about their favorite celebrities. These and other features of the present disclosure will be appreciated from review of the following detailed description of exemplary embodiments, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a schematic of an exemplary embodiment of a communication system and method in accordance with the present disclosure;

FIG. 2 is a process flow diagram showing an exemplary embodiment of an internal data structure for a communication system and method in accordance with the present disclosure;

FIG. 3 is a schematic of an exemplary embodiment of a communication system and method from the celebrity-provider perspective in accordance with the present disclosure;

FIG. 4 is a detail view of an exemplary embodiment of a provider profile page in accordance with the present disclosure;

FIG. 5 is a detail view of an exemplary embodiment of a registration page in accordance with the present disclosure;

FIG. 6 is a detail view of iconography used in exemplary embodiments of a communication system in accordance with the present disclosure;

FIG. 7 is a detail view of an exemplary embodiment of a registration page for selecting interests in accordance with the present disclosure;

FIG. 8 is a detail view of an exemplary embodiment of a registration page for selecting influencers in accordance with the present disclosure;

FIG. 9A is a detail view of an exemplary embodiment of a home page for selecting interests in accordance with the present disclosure;

FIG. 9B is a detail view of an exemplary embodiment of a home page for selecting interests in accordance with the present disclosure;

FIG. 10 is a detail view of an exemplary embodiment of an interests page in accordance with the present disclosure;

FIG. 11 is a detail view of an exemplary embodiment of an influencers page in accordance with the present disclosure;

FIG. 12 is a schematic showing an exemplary taxonomy of fan-user interests for exemplary embodiments of a communication system in accordance with the present disclosure;

FIG. 13 is a diagram showing an exemplary media sourcing schema for exemplary embodiments of a communication system in accordance with the present disclosure;

FIG. 14 is a schematic showing an exemplary taxonomy of information collected from users in exemplary embodiments of a communication system in accordance with the present disclosure;

FIG. 15 is a detail view of an exemplary embodiment of a sign-in page for selecting interests in accordance with the present disclosure;

FIG. 16 is a detail view of an exemplary CARD UX structure utilized in exemplary embodiments of a communication system in accordance with the present disclosure;

FIG. 17 is a detail view of an exemplary CARD UX structure utilized in exemplary embodiments of a communication system in accordance with the present disclosure;

FIG. 18 is a schematic of an exemplary embodiment of a communication system and method in accordance with the present disclosure; and

FIG. 19 is a detail view of an exemplary embodiment of a share page for selecting interests in accordance with the present disclosure.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects. Reference to temperature, pressure, density and other parameters should be considered as representative and illustrative of the capabilities of exemplary embodiments, and embodiments can operate with a wide variety of such parameters. It should be noted that the figures do not show every piece of equipment, nor the pressures, temperatures and flow rates of the various streams.

Embodiments of the present disclosure utilize relevant social networking, online video and music media, and novel information aggregation technologies to create a new platform for entertainment-centered musicians, athletes, other celebrities, and brand owners to deliver engaging information to their audiences. Exemplary embodiments of a mobile/desktop app are advantageously easy to set up, easy to use, and highly cost effective for the information providers to broadcast their latest music, videos and photos, news, event information, merchandise, and biographies. For celebrity-providers, platforms of the present disclosure deliver a robust app that brings captivating experiences to their consumer audience. Exemplary embodiments advantageously allow information providers to combine their existing multi-platform online assets into a single uniform network of similar brands, increasing overall exposure and brand awareness. Both fan-users and celebrity-providers can have a turn-key interface that works with existing services and is quick to integrate into a user's everyday routine.

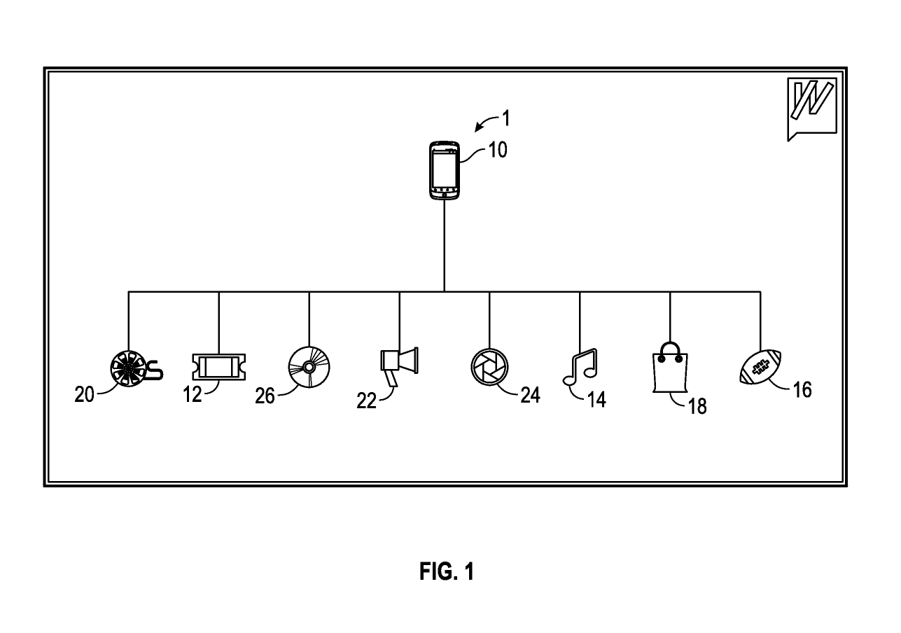

In exemplary embodiments, fan-users can subscribe to their choice of validated celebrity-providers. Once subscribed, as shown in FIG. 1, the fan-users can immediately view information or opt in to receive notifications on their computer or mobile device 10 regarding, e.g., new events 12, songs 14, sporting events 16, shopping information 18 or deals, movies 20, social network posts or announcements 22, photographs 24, other media 26 and other information 30 disseminated by the celebrity-providers. As discussed in more detail herein, exemplary platforms provide fan-users with an easy-to-use catalog of their favorite celebrity-providers, with the most important and current information delivered in an intuitive manner. As seen herein, the user interface is intuitive, has little or no learning curve, and minimizes page re-directs.

Exemplary embodiments of systems and methods 1 useful in transmitting information from celebrity-providers to fan-users are based on a Model View Controller (MVC) pattern. In exemplary embodiments, the internal structure of exemplary systems may be written in PHP. A PHP interface manages incoming and outgoing messages and a MySQL database, which provides centralized storage of user data. Celebrity-provider data may be held in unique XML files generated from a model and various handlers.

In exemplary embodiments, the global data structure of the system is characterized by the XML files representing a celebrity-provider's profile. In exemplary embodiments, a database is not used as the primary data structure, and is used only for private user data such as email addresses, passwords, and other contact information.

In exemplary embodiments, temporary data structures may refer to the data objects that are stored on the client side device and also to the XML objects that are interchanged between the server and client. The data objects created on the local device may be compressed, and many will exist until the system is uninstalled or until the temporary files are cleared. This allows offline support of previously viewed profiles.

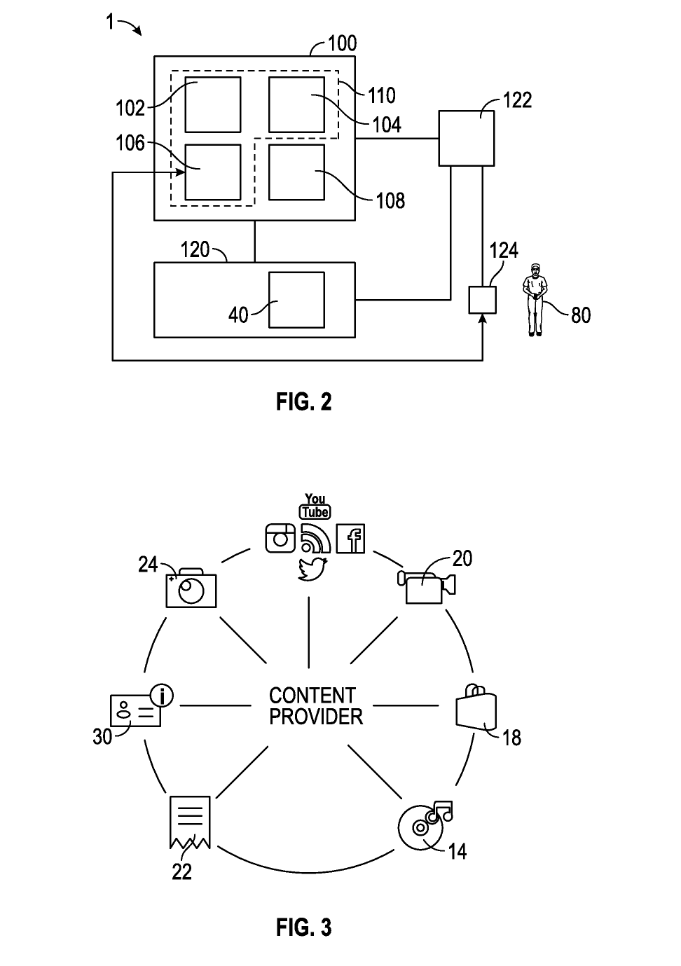

With reference to FIG. 2, in exemplary embodiments, the system 1 comprises a global data structure 120 representing at least one celebrity-provider profile 40, an internal data structure 100 coupled to the global data structure 120, and a computer server 122 coupled to the global data structure and the internal data structure. The system 1 further comprises a fan-user interface 124 coupled to the computer server 122. the internal structure 100 of the system 1 is divided into four parts: one or more models 102, one or more views 104, one or more controllers 106, and one or more handler classes 108. A model may be knowledge or data. It could be a single object, or it could be some structure of objects. In exemplary embodiments, there is a one-to-one relationship between the model, on one hand, and the represented world as perceived by the owner of the model, on the other hand. In exemplary embodiments, models in the system access data handler classes that are isolated from the MVC system 110.

In exemplary embodiments, a view 104 is a visual representation of its model 102. It would ordinarily highlight certain attributes of the model and suppress others. It is thus, in exemplary embodiments, acting as a presentation filter. In exemplary embodiments, a view is attached to its model 102 (or model part) and gets the data necessary for the presentation from the model by asking questions. It may also update the model 102 by sending appropriate messages. All these questions and messages have to be in the terminology of the model 102. Thus, in exemplary embodiments, the view 104 will know the semantics of the attributes of the model 102 it represents. A view 104 in exemplary embodiments of the system is essentially a template that takes in values from models 102.

In exemplary embodiments, a controller 106 is the link between a fan-user 80 and the system 1. It provides the fan-user 80 with input by arranging for relevant views to present themselves in appropriate places on the screen. It provides means for user output by presenting the fan-user with menus or other means of giving commands and data. In exemplary embodiments, the controller 106 receives such user output, translates it into the appropriate messages and passes these messages on to one or more of the views 104.

In exemplary embodiments, a handler class 108 is a logical component used to translate data types when passing between objects or to parse XML files or similar file types. A handler 108 may be isolated from the MVC system 110. It organizes data in a specific manner for its target model 102 to receive. A handler class 108 may also be used to translate user input into a format which the controller 106 can understand. Handlers 108 convert raw data into organized chunks that are directed towards their respective components, i.e., models 102 or controllers 106.

Turning to FIG. 3, in exemplary embodiments a celebrity-provider can create an account and a profile. This profile allows entertainment-centered musicians, athletes, and other celebrities and brand owners to deliver complete information about themselves to their audiences. In exemplary embodiments, a provider is a User Account object that extends the provider class. A provider account may need to access various outside sources such as online social networks 28 for new information as fan-users view the celebrity-provider profile. Because accessing those outside sources each and every time is not efficient, the system stores the retrieved information. When a fan-user views a celebrity-provider profile, the outside source and be compared to the server. If nothing has changed on the source side, the user will load this XML cache. The cache may be stored locally on a user's device, after viewing, for offline use. Each outside source may have its own class that handles retrieval/storage of information. An exemplary XML hierarchy (shown as element: attributes) for a celebrity-provider profile is as follows:
Artist: id, name, category, unixTimeStamp
   ProfilePic: url
   Bio
   Genre
   Label
   SimilarArtists
      SimilarArtist: id, name, url
   Location
   Pics
      Pic: url
   Social
      Facebook: fbid, start, total
         Post: type, unixTimeStamp, url, content
      Twitter: twid, start, total
         Post: type, unixTimeStamp, url, header, content
      Youtube: ytid, start, total
         Video: unixTimeStamp, url, header
      Instagram: igid, start, total
         Post: unixTimeStamp, url, header
   Songs
      Song: id, name, price, explicit, name
   Merch
      Item: id, name, price, pic, details
   Videos
      Video: id, url, pick, name, feat
   Events
      Events: id, url, mapImage, eventTitle, venue, address, month, day, year, time, period, attending

In exemplary embodiments, a provider account is categorized by one of the following. The celebrity-provider may be an Artist, e.g., singer, musician, songwriter, other creative individual, etc. The celebrity-provider may be an Entertainer, e.g., actor, comedian, magician, host, multi-focused provider, etc. The celebrity-provider may be an Athlete, e.g., sports team member, individual athlete, etc. The celebrity-provider may be a Band, i.e., a group of artists under one name. The celebrity-provider may be a Brand, i.e., a named company, good, or service. The celebrity-provider may be a Representative, e.g., an artist manager, an athlete manager, a team owner/manager, etc.

When a provider creates an account, he or she is prompted to choose one of the six primary categories. In exemplary embodiments, the Artist and Brand categories also ask the provider to specify a genre. After account creation, the providers may choose to change their category if they see fit, or create custom sub-categories. The sub-categories are a separate collection of optional categories that apply to one or more primary categories and are there to further specify a provider's area of expertise. Examples for Artist are musician, vocalist, songwriter, guitarist, bassist, drummer, DJ, producer, choreographer, photographer, or visual designer. Examples for Entertainer are host, actor, actress, magician, improve performer, circus performer, street performer, stung performer, dancer, theater. Examples for Athlete are football, soccer, baseball, tennis, auto racing, hockey, boxing. Examples for Representative are producer, manager, attorney, agent, publicist, union, performance rights organization, promotor, booking agent.

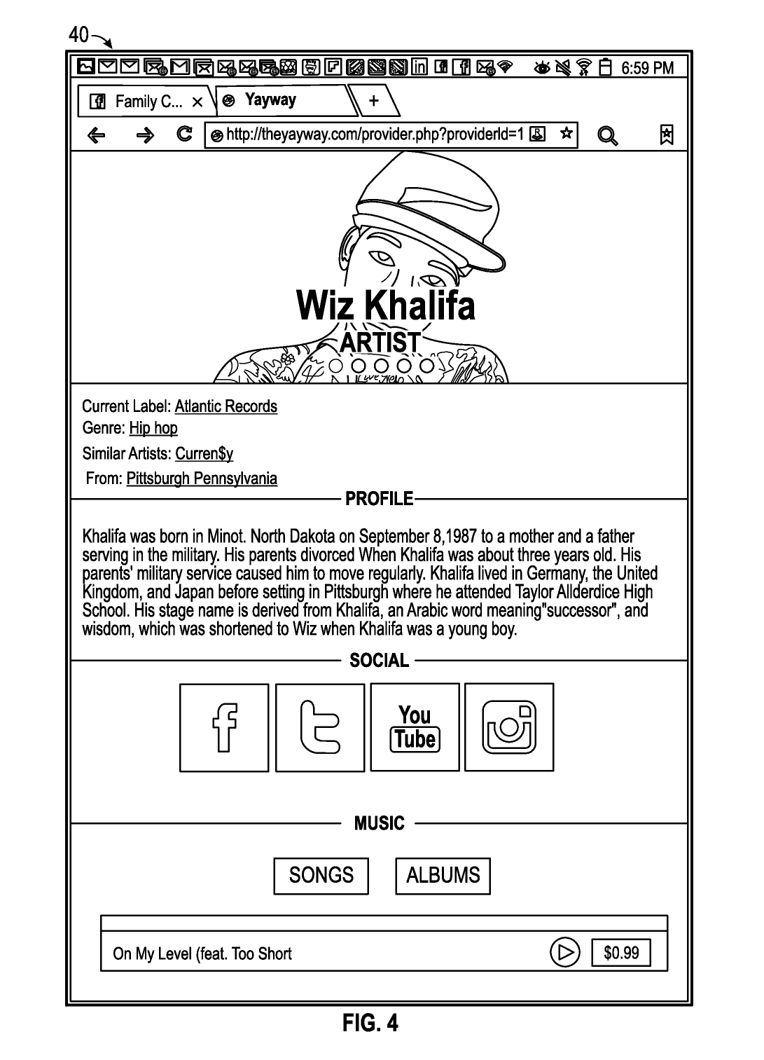

Thus, as shown in FIG. 4, providers create provider profiles 40, a core feature of the system and the main hub for provider information. The profile 40 may include the provider name, category, biography, social feeds, category-specific info such as music and albums if the provider is a musician, merchandise, videos, and events. A provider may also have access to a Dashboard, allowing them to edit their profile information and view fan-user analytics about their profile. For musician providers, they can provide to their fan-users the ability to preview or purchase songs or albums, through iTunes® or Google Music.

Fan-users can also create accounts so they can select what kind of information they want to receive about their favorite celebrities. In exemplary embodiments, the UserAccount class represents a system user account and includes a unique identifier, the user's email address, and any other pertinent information. UserAccount objects are mean to represent a user within the system, and consequently there is one unique UserAccount object associated with each user.

When a user, which could be fan-user or a celebrity-provider, first creates his or her account, a new UserAccount object is created. This object is responsible for storing information unique to the fan-user. This may include one or more of: a user ID, account type (Fan or Provider), Billing Package, Email address, first and last name, gender, location, groups of providers selected by the user via ‘Subscriptions’ and list formatting information. When a user first registers for an account, he or she inputs a first name, last name, and valid email address. The UserAccount constructor is called and this information is passed, creating a new UserAccount object for that user. Any time information related to a user is required, the UserAccount object is called upon. A UserAccount may either stand alone or extend the provider class. This is determined by the type of account the user is creating. This class assumes the user has selected to be a fan and not a provider. Any methods related to a provider are in its respective class.

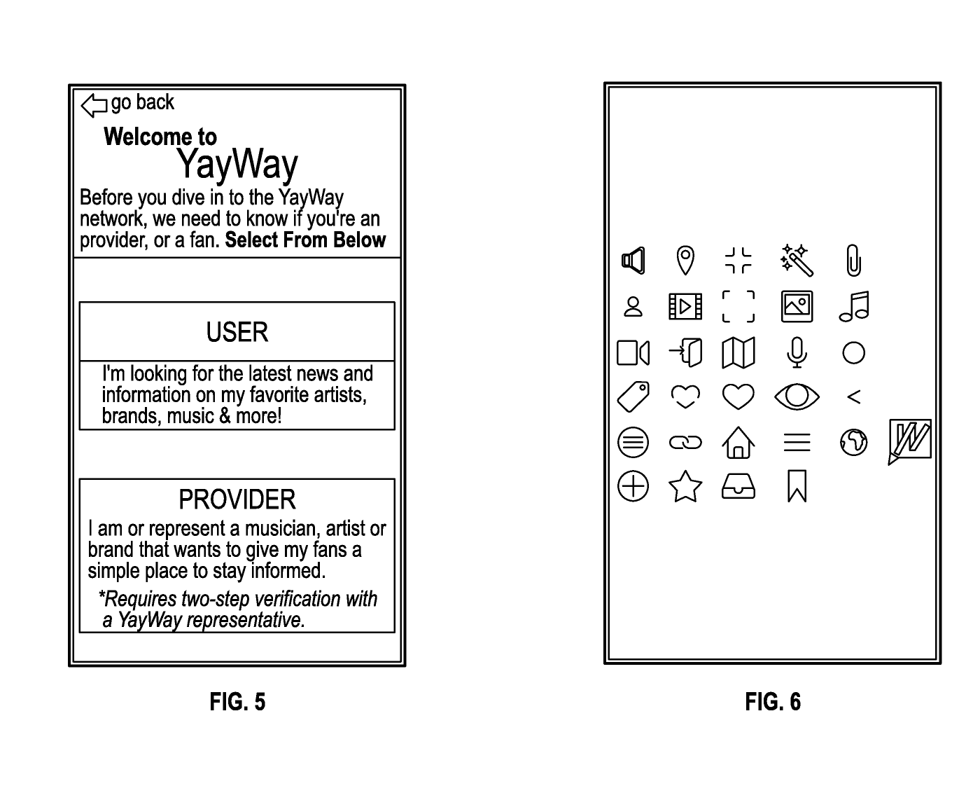

Referring to FIG. 5, the new user is presented with a choice between registering as a provider or a fan, and is supplied with descriptions for each. As discussed in detail herein, a provider or celebrity-provider is a user who provides content. A fan or fan-user is a user who view provider profiles and content. If the user selects provider, he or she is prompted with a series of pages, first basic information to be filled in, e.g., provider name, provider representative, provider category, phone number, email address, password, password confirmation, terms of service/ privacy statement radio box. A submit button is pressed when the user is finished entering the information. The information is then passed into a handler that validates the information entered. If any information entered does not pass validation, the user is returned and notified of the incorrect field. If validation successfully completes, the user is directed to the next step.

The user is then asked to provide social information using a full URL for, e.g., Facebook®, Twitter®, Instagram®, Youtube®, Vimeo®, Google+®, etc. After the user has filled in the social networks they wish to include, a “next” button is pressed to continue to the next page. At this point, the social network URLs are sent through a handler to validate that the URLs and profiles exist. If any information entered does not pass validation, the user is returned and notified of the incorrect field. If validation successfully completes, the user is directed to the next step. The user is now asked to link their social network account with the system. After integration of the social networks, a final provider validation email is sent to the provider outlining the provider validation options that must be completed prior to account generation. The user can then access the user interface, which in exemplary embodiments, consists of a series of pages allowing the user to complete various actions that communicate with the server. The pages may include a “Welcome Page,” a “Home Page,” multiple “Provider Profiles,” the “Provider CMS,” and “Provider Settings” page. As seen in FIG. 6, basic iconography is provided on the user interface. The iconography puts a visual language in pace to assist in organizing the current chaos of media choices, subjects, and opportunities for users of the system.

An exemplary UserAccount interface description is shown below.
new (string firstName, string lastName, string email)
setLastName (string newFirstName)
getFirstName ( ) as String
setLastName (string newLastName)
getLastName ( ) as String
setEmail (string newEmail)
getEmail ( ) as String
getID ( ) as int
getLists ( ) as Lists [ ]
addList (string listName)
moveList (int listPosition)
removeList (int listId)
addToList (int providerId, int listId)
moveInList (int listSlotPosition)
removeFromList (int ProviderId, int listId)
attendingEvent ( ) as bool
pullDataFromServer ( ) as bool
pushDataToServer ( ) as bool

First, in the “new” function, when a user first registers for an account, he or she inputs a first name, last name, and valid email address. The UserAccount constructor is called and this information is passed, creating a new UserAccount object for that user. In the “addList” function, when a user wants to organize their provider subscriptions into a new list, this method is invoked to create a new list entry in the lists table and defaults to the toplist position. The “removeList” function is invoked to remove a specified list entry when a user decides he or she doesn't want a list. In the “addToList” function, when a user subscribes to a provider, he or she is asked to select a list to add the provider to. Upon list selection, the provider is added to the specified list at the front slot by default. “removeFromList” is invoked to remove a provider from a list entry when the user wants to remove a particular provider from their list.

The “attendingEvent” function is used when a user purchases an event ticket or manually specifies that they are attending an event. This method signifies various UI changes including the “Attending” tag displayed over the event. If a list is created or modified, the user involved must have their UserAccount object updated to reflect the changes. When the “pullDataFromServer” method is called, all UserAccount information stored on the server replaces this UserAccount information if it has been changed. The “pushDataFromServer” method performs the opposite function of pullDataFromServer: it replaces outdated UserAccount information on the server with the UserAccount information stored on the device.

In exemplary embodiments, the UserAccount class includes accessors, mutators, and process that communicate with the server. Because it is mainly used for data storage/retrieval, there typically will be no algorithms associated with the UserAccount class. In exemplary embodiments, the UserAccount class has no parent or child classes. However, each list may have an associated UserAccount, which is not necessarily unique to that list.

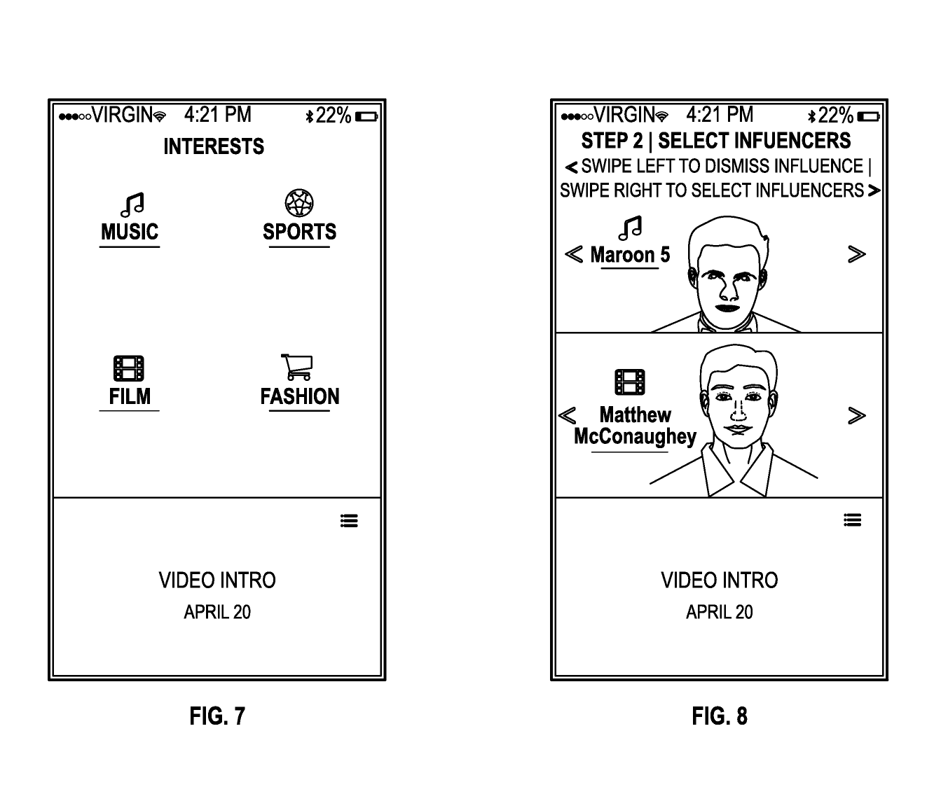

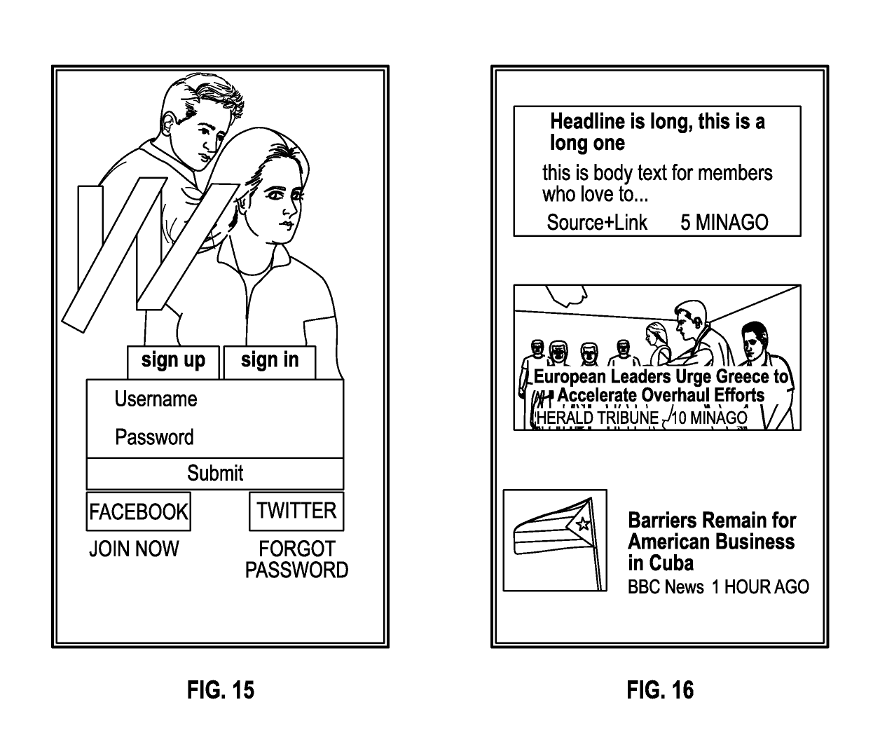

In exemplary embodiments, wireframes are utilized to be responsive, so all elements are liquid—built to live on all screen sizes—scaled up or down based on media queries related to users' available screen size. For example, at a sign-up or sign-in screen, best seen in FIG. 15, a user landing is prompted to SIGN UP to join the conversation, which can be done using a social networking site or micro-blog or a user name and password. The user can request a missing password, which will be sent to user after the email address is provided. A subsequent screen (“onboarding”), shown in FIG. 7, prompts the user to select interests from an interest list. In exemplary embodiments, the user must select at least two interests in order to advance. Tooltip will inform the user if the submission is made before the minimum number of interests are selected. The user can then watch the overview video. A check appears on any box to indicate tap/click/select. The user can swipe left to see the next page block of interest choices if all are not presented on the screen.

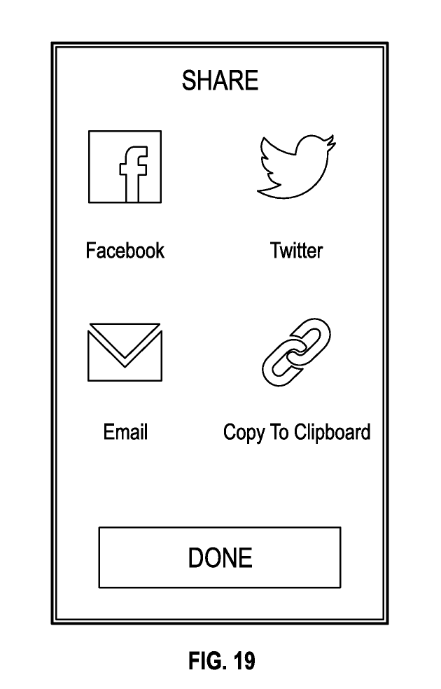

Turning to FIG. 8, the next screen prompts the user to select influencers from per interest influencers list. In exemplary embodiments, the user must select at least five influencers in order to advance. Selection mirrors provide “in app swipe to dismiss” or “share” functionality (shown in FIG. 19). The user can swipe influencer cards in one direction (e.g., left) to dismiss, and then another card from the same interest area is populated. The user can swipe influencer cards in the other direction (e.g., right) to select the influence, and another card from the same interest area is populated. The user can then watch the onboarding video, and after choosing at least five influencers, is provided a go to feed button.

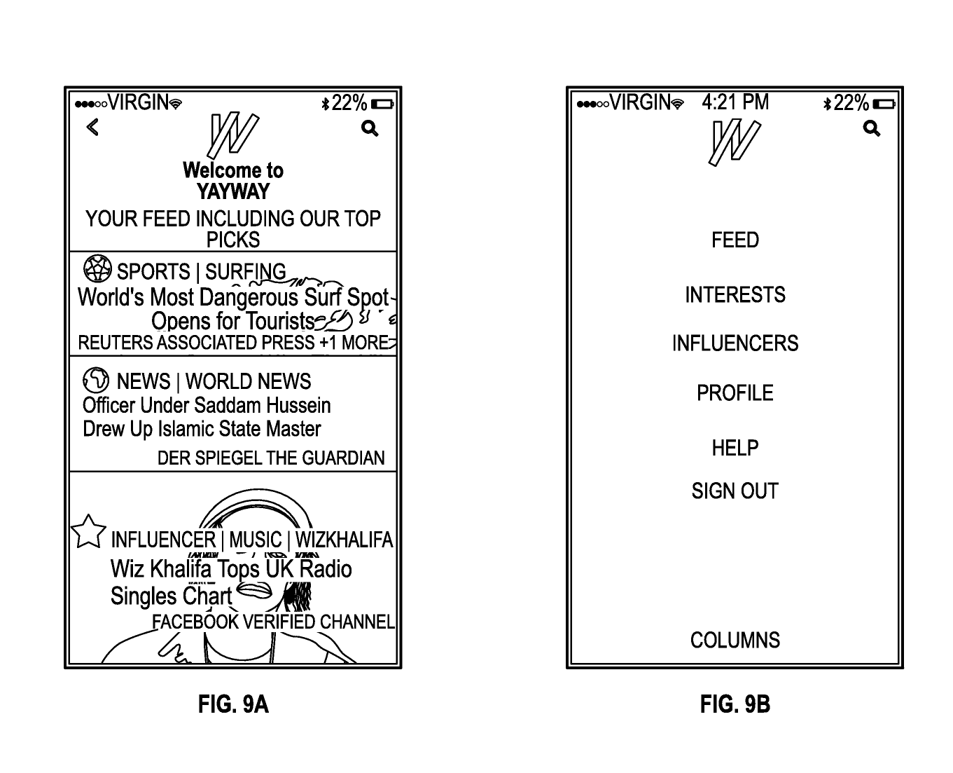

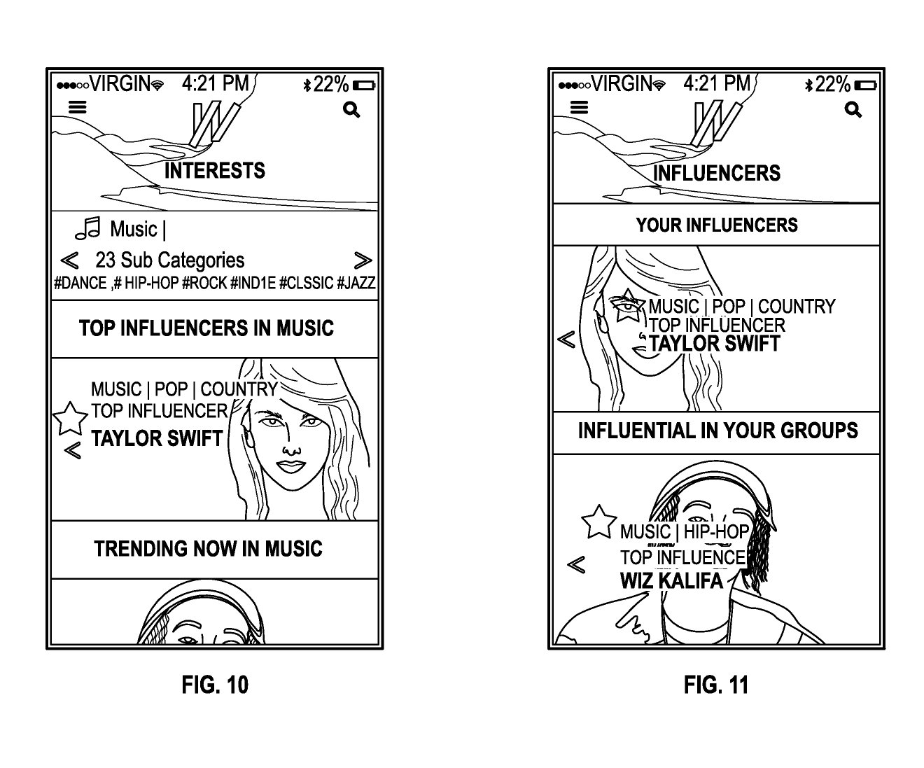

With reference to FIG. 9A, the feed screen (home) is the default home page for signed-in users. The feed screen exposes the entire side navigational menu and lists in order of time (currentness) feed entries from the influencers and interest areas the user has selected, as refined by actual user data. From the feed screen, the user can browse feed entries, expand feed entries, dismiss feed entries, bookmark feed entries, share feed entries, navigate the main menu, and search for new influencers, interests, and do key word searching. As shown in FIG. 9B, a home page could offer a menu leading to the feed page and to the user's selected interests, influencers, and profile, as well as providing help and sign out options. As best seen in FIG. 10, the interests view allows the user to modify and add interests. Interests can be expanded to show the most influential influencer in interest or the latest tagged feed. The influencer view, shown in FIG. 11, allows the user to modify and add influencers.

Exemplary embodiments of systems and methods useful in transmitting information from celebrity-providers to fan-users provide certain core features. An initial core feature is the user registration and welcome. In exemplary embodiments, this appears upon application launch without authenticated log-in information and allows the users to register. The users can also take a quick tour of the systems without registering to view its features in a user-friendly manner. The registration allows for differentiation between two types of users: fans and celebrity-providers.

Another exemplary core feature is provider lists. These are the fan-user's collection of celebrity-providers they have subscribed to. In addition to the fan-user's chosen lists, some lists appear as defaults to all users, such as Trending, Near Me, Recommended, and Featured. In exemplary embodiments, lists slide or swipe horizontally and display uniform mini-provider profiles. Mini-provider profiles link to the provider's profile and may consist of a picture, name, and category.

Exemplary embodiments include a provider subscription. This allows a fan-user to display the specified provider on their landing page and to opt in to receive notifications regarding new information related to the provider. When the subscription is called by the user, the user is presented with a module asking which list they would like to add the provider to. If no custom lists are available, the user may be asked to create a new list titled “My” by default.

Exemplary embodiments advantageously provide aggregation functionality. Automated social media aggregation provides for the most recent posts to be pulled from the providers' specified social networks. In exemplary embodiments, the four most recent posts are pulled, but this number could be adjusted. Examples of social networks for automated data aggregation via API calls are Facebook®, Twitter®, Instagram®, Youtube®, Vimeo®, and Soundcloud®. Custom web site data aggregation may also be provided so that providers who specify a custom web site can opt in to this feature. Data can be pulled using either a standard XML layout the provider generates or an in-house team could custom tailor an XML parsing method to use on a per-provider basis.

In exemplary embodiments, objects are culled from both off-site (RSS/Social API/ETC) and on-site sources. These may be comments, tweets, messages, articles, images, videos or other media known or not yet known. Each of these objects will be labeled in a consistent manner in order to maximize its usefulness throughout its lifecycle. In exemplary embodiments, some content (not directly submitted media) may be retired on a regular basis to keep the volume of active records low and the system working smoothly at scale. Although the objects will be specifically labeled, the process may be automated and refined through user interactions as well. For example, an object may become more or less likely to a fan-user of a particular celebrity-provider based on the engaged audience in a certain percentage of the celebrity-provider's core audience. In exemplary embodiments, an object may also carry reactions, comments, likes, shares, and other useful information that will continue to allow us to maximize the contextualization of the media and learn what our audience is most engaged with.

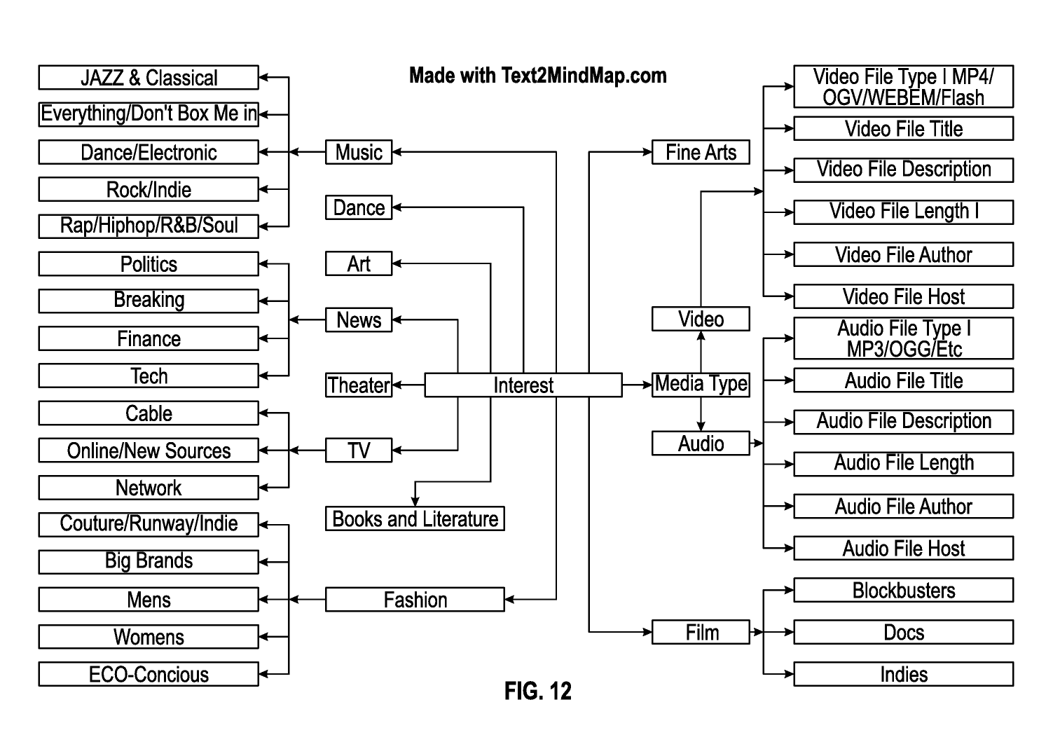

In exemplary embodiments, a taxonomy or schema of fan-user interests will be used. An exemplary taxonomy is illustrated in FIG. 12. The interest may be in, e.g., Music, Film, TV, News, Fashion, or Art. There may be sub-categories of interests under Music, e.g., Dance/Electronic, Rock/Indie, Rap/Hip Hop, Jazz or Classical. Under Film, the subcategories may include Blockbusters, Indies, Documentaries. Under TV, it could be Network, Cable, etc. Under News, the sub-categories may include Breaking, Politics, or Finance. The Fashion sub-categories might include Mens or Womens or Couture/Indie. Under Art, the interests might be Dance, Theater, Fine Arts, Books/Literature. The taxonomy of interests might also provide for a Media Type, such as video, image, slideshow, audio, embedded content/micro-format, mash-up, article, etc. These could have sub-categories such as video/audio file type, video/audio file title, video/audio file length, or video/audio file author, or image file type, image file title, image file description, image file dimensions, or image source. Other major interests could include Source (e.g., particular social networks), Influencer, or Contextual such as trending, geographic importance, or timing.

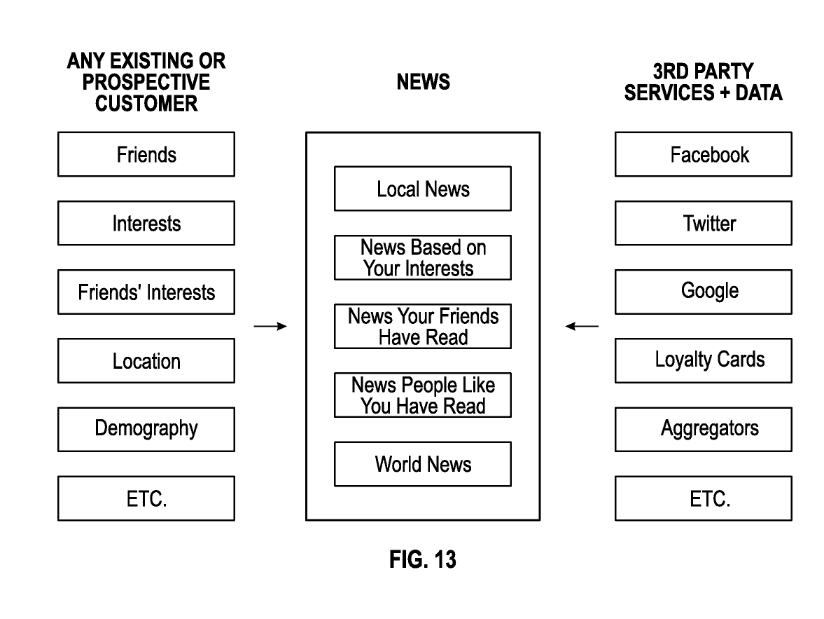

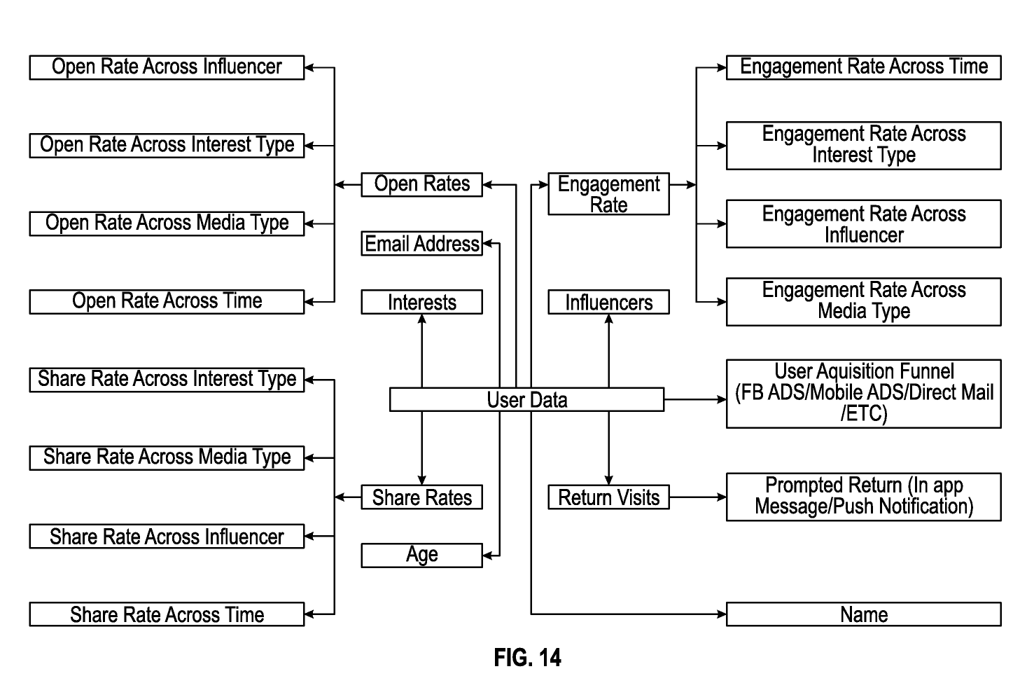

As seen in FIG. 13, from this media sourcing schema, the system advantageously can best match relevant, useful, inspiring content to a particular fan-user. In order to responsively serve the needs of the fan-users, information is presented so it meets brand criteria and is relevant to the expressed and implied preferences, interests, and requests of the fan-user. For the fan-user, the system starts with a block of relevant information and then refines that information based on actual use to systematically and continuously refine the personalized feed results. This is enabled by gathering user data. As shown in FIG. 14, in addition to basic information such as name, age, and email address, other information such as interests, influencers, a user acquisition funnel (social network ads, direct mail, etc.), return visits, share rates, open rates, and engagement rate are collected. The share rate, open rate, and engagement rate could be across time, across media type, across interest type, and/or across influencer.

Supplementing the core features discussed above, exemplary embodiments provide additional features that add extra functionality. These include user settings, so fans and providers and adjust their settings menus and customize their preferences. A Help Menu displays a list of topics covering the different components and offers detailed information on each feature, menu, etc. The “Take a Tour” feature may be on the landing page so individuals who have not signed up or are not logged in can tour the system. Exemplary embodiments may include location based advertising, a platform provided through an outside source. This could provide local offerings relevant to users' viewing patterns. It could advantageously supply users with seamless recommended providers based on their search history. It also provides provider accounts with analytics about user view patterns on their profile. Users could be allowed to give a provider rating, e.g., from 1 to 5. Also, as shown in FIG. 19, the user could be provided with the ability to share providers on various social networks.

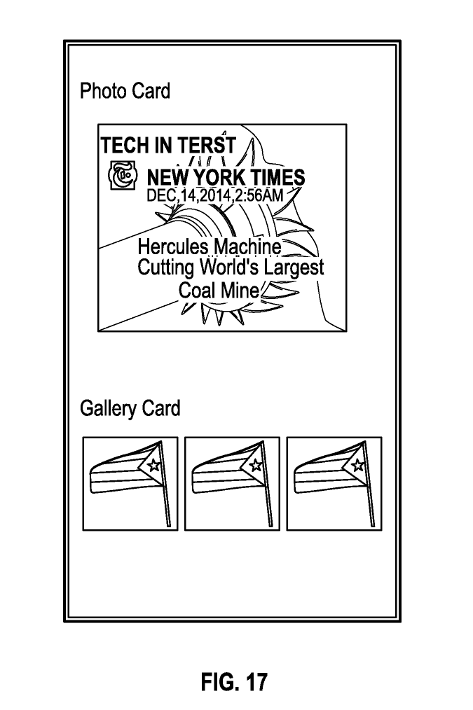

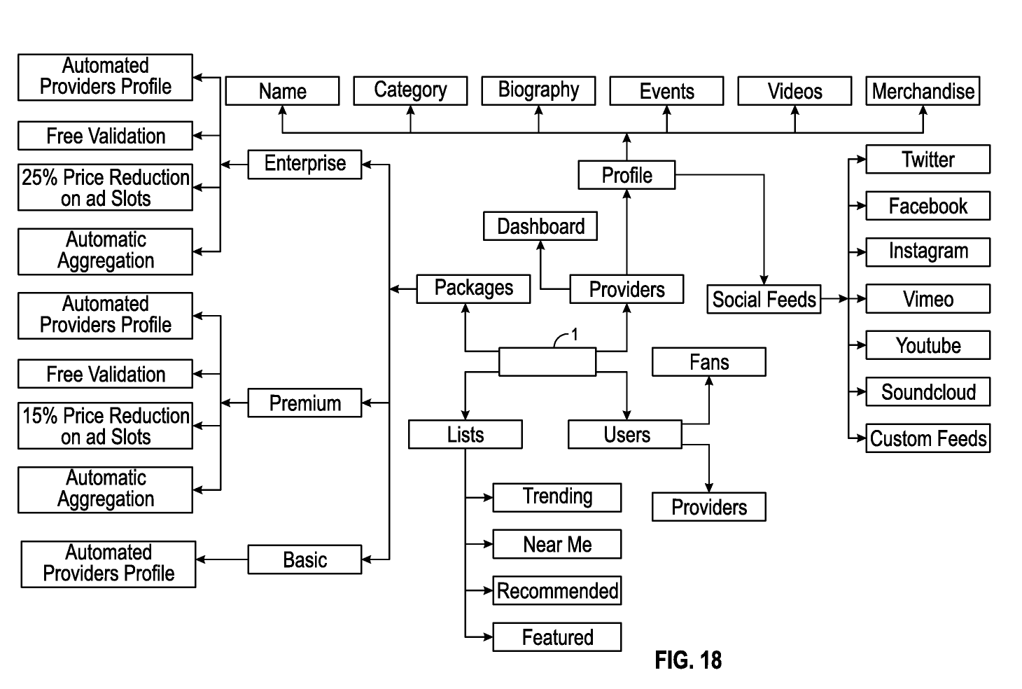

Referring to FIGS. 16-17, in exemplary embodiments a CARD UX structure is utilized to present an optimal user experience. This advantageously provides a cohesive structure that can support all delivery screens and handle content of various formats coming in from a multitude of varied sources. Each of these formats has specific handling requirements, each incoming source may handle passing information to the system in different ways, with different schemas, naming conventions, and taxonomies. Cards allow for a movement away from individual pages all linked together to a single experience that aggregates and teases bits of content from all areas. This structure allows for sharing videos, messages, games, reviews, articles, and other media within one shell site/design mechanism. In addition, a CARD UX structure facilitates discovery. That is, cards are a good way to surface a lot of content for discovery by users and to get discoverers into the content they want. The browse-inducing layout is helpful for blog and article driven sites like magazines, social sites that are sensory driven (photo, video, audio) and e-commerce sites. Exemplary cards, are formatted to handle various media delivery. They are also good ways to provide iconography designed to users.

Exemplary embodiments may link to a micro-blog account associated with a celebrity-provider and/or a micro-blog account associated with a fan-user. In exemplary embodiments, a Twitter® class is provided. The Twitter® class is used to represent a user's Twitter® account and includes a unique identifier, the user's micro-blog URL, and other pertinent information. Micro-blog objects are associated with one or more UserAccounts extending provider in the system, and represent all relevant micro-blog feed, picture, and profile data. When a provider is first created in the system, he or she is asked to enter a Twitter® URL, and at that point a Twitter® object is created. This information may include, the micro-blog ID, the User ID, the micro-blog URL, and blog posts specified by URL. Thereafter, any time information relating to a provider's micro-blog account is required, the micro-blog object is called upon. A Twitter® interface detail and processing sequence is shown below.
new (string url, int user Id)
validUrl (string url) as bool
getTwitterID (string url) as int
getUserID (int twitterId) as int
getPosts (int twitterId) as Posts [ ]
pullDataFromTwitter (int twitterId) as bool
pushToXML (int userId) as bool
new (string url, int userId)
   When a user first registers for an account as a Provider, he/she inputs a Twitter URL if necessary. The Twitter constructor is called and this information is passed, creating a new Twitter object for that user.
validUrl (string url) as bool
   After focusing away from the Twitter field in the provider account creation page of YayWay, this function is run to check if the Twitter account exists.
getTwitterID (string url) as int
   This method is invoked when a standalone Twitter ID is needed for utilizing the Twitter API
getUserID (int twitterId) as int[ ]
   Returns a user ID (or multiple) associated with the specified Twitter ID
getPosts (int twitterId) as Posts [ ]
   Retrieves the last 4 twitter posts on the specified account. This data is used to save the most recent twitter posts to the Provider XML cache. This method will typically only be invoked if the most recent post differs from the cache, and is typically directly followed by pushToXML.
pullDataFromTwitter (int twitterId) as bool
   This method is invoked during initial Provider profile generation. It retrieves all information offered by Twitter API regarding the specified twitterId, only limiting the number of posts retrieved 4.
pushToXML (int userId) as bool
   After posts or otter data have been retrieved, it replaces outdated information in the Provider cache (see 2.4 Provider XML Description for details on how the cache is formatted)

Turning to FIG. 18, in exemplary embodiments of the system 1, subscription options may include an Enterprise Package 60 with a month-by-month fee or annual fee. This would provide the user with a completely automated profile 50 with all features, free validation 52, a percentage price reduction on featured advertising slots 54, a free “token” for advertising service, automated aggregation 56, in-depth analytics, and first access for future features as released. A Premium Package 62 with a lower fee would provide a completely automated profile with all features, free validation 52, a smaller percentage price reduction on featured advertising slots 55, and basic analytics. A Basic Package 64 provides a profile generated from entered social networks and provider validation but would exclude an automated social feed and automated aggregation after the initial set-up.

Providers could pay per week or month for featured home page advertising such that relevant providers show up on a special homepage row displaying their mini-profile among other relevant featured providers. Another option is featured overlay advertising, paid per view, wherein relevant providers show up on a special homepage row displaying their mini-profile among other relevant providers.

Partnerships could be created with existing major record labels or umbrella corps for capital. In exemplary embodiments, partners receive exclusive benefits such as a fixed number of artist's slots free of charge. Co-partnerships would offer products from each respective party on the system with the partner offering system provider profiles or other products. The system could also have a featured provider of the day where providers can pay to schedule a day to be featured. In exemplary embodiments, the provider of the day would have a professionally written editorial sponsoring their brand or product. It could be sourced on a blog and fed to the app. The trending provider of the day is the most viewed profile from the day before. The provider would be contacted and an editorial team would speak with the managers to discuss details of their advertising space. It could be sourced on a blog and fed to the app.

Thus, it is seen that and methods of transmitting information from celebrity-providers to fan-users are provided. It should be understood that any of the foregoing configurations and specialized components or processes may be interchangeably used with any of the systems of the preceding embodiments. Although illustrative embodiments are described hereinabove, it will be evident to one skilled in the art that various changes and modifications may be made therein without departing from the disclosure. It is intended in the appended claims to cover all such changes and modifications that fall within the true spirit and scope of the disclosure.

What is claimed is:

1. A system useful in transmitting information from celebrity-providers to fan-users, the system comprising:
a global data structure representing at least one celebrity-provider profile;
an internal data structure coupled to the global data structure, the internal data structure including:
a handler class programmed to convert raw celebrity-provider data into organized celebrity-provider data;
at least one model representing the organized celebrity-provider data, the model accessing the at least one handler class;
at least one view attached to a corresponding model and being programmed to retrieve the celebrity-provider data from the corresponding model; and
a controller coupling the system to one or more fan-users, the controller being programmed to provide at least one view to one or more fan-users;
a computer server coupled to the global data structure and the internal data structure;
wherein the internal data structure is programmed to combine multi-platform online assets of a celebrity-provider into a single uniform network accessible by fan-users.

2. The system of claim 1 further comprising a fan-user interface coupled to the computer server.

3. The system of claim 1 wherein the internal data structure aggregates celebrity-provider data from online social networks specified by the celebrity-provider.

4. The system of claim 1 wherein fan-users can subscribe via a web application.

5. The system of claim 1 wherein the celebrity-provider data is held in unique XML files generated from at least one model and at least one handler class.

6. The system of claim 1 further comprising at least on temporary data structure stored on a fan-user device.

7. The system of claim 1 wherein the controller allows the one or more fan-users to enter one or more messages relating to desired views and transmits the messages to at least one view.

8. The system of claim 7 wherein the view receives the messages from the controller and performs one or more of: highlighting and suppressing certain attributes of the corresponding model such that the view presents the attributes of the model desired by the one or more fan-users.

9. The system of claim 1 further comprising one or more of: a micro-blog account associated with a celebrity-provider and a micro-blog account associated with a fan-user.

10. The system of claim 1 wherein the celebrity-provider is one or more of: an artist, an entertainer, an athlete, a musical group, a brand, or a representative.

11. A method of communicating information between celebrity-providers and fan-users, the method comprising:
aggregating raw celebrity-provider data specified by a celebrity-provider;
converting the raw celebrity-provider data into organized data chunks;
accessing the organized celebrity-provider data and directing the organized celebrity-provider data to a model or controller;
retrieving the organized celebrity-provider data from the model or controller;
allowing one or more fan-users to enter one or more messages relating to desired attributes of the organized celebrity-provider data; and
performing one or more of: highlighting and suppressing certain attributes of the organized celebrity-provider data and presenting the desired attributes of the organized celebrity-provider data to the one or more fan-users.

12. The method of claim 11 further comprising collecting and storing unique fan-user identifying information.

13. The method of claim 11 further comprising allowing a celebrity-provider to create at least one celebrity-provider profile.

14. The method of claim 11 further comprising creating at least on temporary data structure stored on a fan-user device.

15. The method of claim 11 further comprising providing a fan-user interface for presenting the desired attributes of the organized celebrity-provider data to the one or more fan-users.

16. The method of claim 11 wherein fan-users can subscribe to receive the desired attributes of the organized celebrity-provider data via a web application.

17. The method of claim 11 further comprising holding the celebrity-provider data in unique XML files.

18. The method of claim 15 further comprising linking the fan-user interface to a micro-blog account associated with the fan-user.

19. The method of claim 11 further comprising retrieving raw celebrity-provider data from a micro-blog account associated with the celebrity-provider.

20. The system of claim 1 wherein the organized celebrity-provider data is presented by a card UX structure.
